(19) United States
(12) Patent Application Publication
(10) Pub. No.: US 2019/0208092 A1
(43) Pub. Date: Jul. 4, 2019

(54) VIDEO AND AUDIO SYSTEM FOR A FIREARM

(71) Applicant: Edward Patton, Rochester, NY (US)

(72) Inventor: Edward Patton, Rochester, NY (US)

(21) Appl. No.: 15/862,337

(22) Filed: Jan. 4, 2018

(51) Int. Cl. H04N 5/225; F41C 27/00; H04N 7/18; H04W 4/70

(52) U.S. Cl. CPC H04N 5/2253; F41C 27/00; H04W 4/70; H04N 5/2252; H04N 7/185

(57) ABSTRACT

A video camera system for a handgun having two sides and a handgrip, the video camera system including at least one video camera having a field of view pointed in a direction substantially similar to the direction of a projectile of the handgun and the at least one video camera is configured to be disposed on at least one of the two sides of the handgun above the handgrip.

### BACKGROUND OF THE INVENTION

### 1. The Field of the Invention

The present invention relates to a video and audio system for a firearm. More specifically, the present invention is directed to a video and audio system for a handgun, e.g., pistol and revolver.

### 2. Background Art

The availability and presentation of evidence is crucial in the judicial process. Often times, law enforcement agencies rely on evidence obtained based on inferences from various sources, e.g., crime scenes, weapons or any tools or artifacts connected to the crime scenes. More recently, law enforcement agencies have started to adopt visual technologies by providing cameras attached to a portion of the clothing of law enforcement officers, commonly known as “body cameras.” The collection of data from cameras attached to the clothing have yielded some useful results in certain law enforcement agencies. However, when disposed on a portion of the clothing, the view of a camera may still be obscured by the user's arms or other objects, e.g., walls, furniture, etc. Recently, some pistols have been equipped with video cameras where video cameras are attached to barrels of pistols. Although such arrangements may produce some useful footages of scenes in which pistols are pointed at, a camera mounted to the barrels may alter the mechanics of firing the pistol to which the camera is attached as the additional weight of the camera is disposed at a location far from the handgrip of the pistol, thereby causing the camera to behave as a cantilever. Further, a pistol with a barrel-mounted camera may not be used with an existing holster of the pistol as the barrel end of the camera is made bulky. Further, with a pistol having a slideable barrel, disposing a video camera on the front end of the pistol requires a specialized adaptor to secure a video camera to a non-moveable part of the barrel. Again, disposing a video camera system at the barrel increases its bulk and causes it to suffer from the problems previously disclosed.

U.S. Pat. Pub. No. 20080233543 of Guissin (hereinafter Guissin) discloses a video camera and recording device integrated with a real or toy weapon to provide video recording of the assault and aiming process of the weapon holder in operational training, actual combat, hunting, sports and gaming scenarios. A video camera is boresighted with the weapon, and a video memory stores the recorded dynamic scenario, and a trigger sensor which continually senses and records the triggering actions imposed by the weapon holder. The trigger sensor is attached to the actual trigger of the weapon thus enabling normal operation of the weapon. The video camera, may be mounted internally within the bore of the weapon, such that the external form of the weapon is not altered, thus achieving closer operation to real life situations. The recorded trigger data is utilized upon playback of the recorded video, enabling review and scoring of the recorded aiming process for training and gaming. Guissin discloses a video recording device that is disposed in the bore of a firearm when no actual firing occurs, in a training bullet when firing is required or the end of a barrel.

U.S. Pat. Pub. No. 20050179799 to Umanskiy et al. (hereinafter Umanskiy) discloses a video camera mounted to a magazine of a semi-automatic handgun along with a weapon system incorporating the magazine-mounted video camera. In at least one embodiment, a small video camera is attached to a bottom plate of the ammunition magazine. The video camera is operatively coupled with a small portable video monitor that is carried or worn be the user. Accordingly, the user can use the firearm mounted camera to survey a scene while protected by a barrier or the user can use the video sighting system to survey a scene in no or low light situations. Umanskiy configuration is unsuitable for a user accustomed to the cupping of his hands while holding the handgun as the views of the magazine-mounted video camera will be obscured. Further, a video camera-equipped magazine will be required. Therefore, a user may not swap an empty magazine with a ubiquitous magazine, limiting the availability of a video camera-equipped handgun.

Various mechanisms have been used to switch on or off devices of a handgun. U.S. Pat. No. 8,109,024 to Abst (hereinafter Abst) discloses a trigger activated switch for a firearm. The switch comprises a Hall-effect sensor configured to be mounted in the housing or frame of the firearm, and a magnet disposed on a retractable member coupled to the trigger of the gun. The trigger comprises a firing module rotatably coupled to the housing to have a range of motion with respect to the housing from a non-firing position to a firing position. The retractable member is moveably coupled to the firing module and articulates between a non-engaged position and engaged position with respect to the firing module. The Hall-effect sensor is attached to the firearm housing in proximity to the magnet when the retractable member is in the non-engaged position. Motion of the retractable member from the non-engaged position to the engaged position causes the magnet to articulate away from the sensor, which then activates an auxiliary device upon sensing motion of the retractable member. The trigger activated switch may not be suitable for a video camera meant to capture scenes before and after an incident as the video camera is not turned on until a user places his finger at the trigger.

There arises a need for a video camera-equipped handgun that can readily be used with an existing unmodified holster, one which does not alter the recoil characteristics of a handgun, one which is configured to be turned on only during opportune times (e.g., when deadly force is used) and one which is optimized for its power usage.

### SUMMARY OF THE INVENTION

In accordance with the present invention, there is provided a video camera system for a handgun having two sides and a handgrip, the video camera system including at least one video camera having a field of view pointed in a direction substantially similar to the direction of a projectile of the handgun and the at least one video camera is configured to be disposed on at least one of the two sides of the handgun at a top portion of the handgrip.

In one embodiment, the video camera system further includes at least one second video camera having a field of view pointed in a direction opposite to the field of view of the at least one video camera.

In one embodiment, the video camera system further includes a camera support unit functionally coupled to the at least one video camera, the camera support unit is configured to be disposed within the handgrip.

In one embodiment, the camera support unit includes a battery adapted to power the at least one video camera.

In one embodiment, the video camera system further includes a Global Positioning System (GPS) configured to indicate a location of the handgun.

In the embodiment, the video camera system further includes a switch means configured to detect a grip of the handgrip and a data recorder functionally connected to the at least one video camera, wherein upon the detection of a grip, the video camera and the data recorder are turned on and upon cessation of the detection of a grip, the video camera and the data recorder are turned off.

In one embodiment, the switch means is a mechanical pressure switch. In another embodiment, the switch means is a heat sensitive switch.

In one embodiment, the data recorder includes a data access port.

In one embodiment, the data recorder includes a remote communication device configured to transmit data of the data recorder to another device.

In one embodiment, the system further includes a switch means configured to selectively turn on or off the at least one video camera and the data recorder.

In one embodiment, the system further includes a grip panel having a lateral surface and a switch configured to selectively turn on or off the video camera and the data recorder, the grip panel is configured to be disposed on one of two sides of the handgrip and the switch is removably attached to the lateral surface of the grip panel so as to be accessible on the lateral surface of the grip panel.

In one embodiment, the system further includes a switch means configured to detect a grip of the handgrip, a data recorder functionally connected to the at least one video camera and a functionally coupled wireless device pair, wherein a first wireless device of the wireless device pair is configured to be attached to the handgun and a second wireless device of the wireless device pair is configured to be coupled to a holster of the handgun, wherein upon the detection of a grip, proximity detection of the wireless device pair is started, and if the first and second wireless devices of the wireless device pair are determined to be sufficiently separated by a separation, the video camera and the data recorder are turned on, wherein if the detection of a grip does not occur and if the first and second wireless devices are determined to be not sufficiently separated, then the video camera and the data recorder are turned off.

In one embodiment, the separation is an event selected from the group consisting of a loss of communication between the functionally connected wireless device pair and a distance between the functionally coupled wireless device pair exceeding a pre-determined threshold.

In one embodiment, the wireless device is a device selected from the group consisting of a radio frequency device, a Bluetooth device, a Wi-Fi device, a Hall Effect device, an induction device, and any combinations thereof.

In one embodiment, the system further includes an audio input device configured to receive audio input from the surroundings of the handgun.

In one embodiment, the at least one video camera further includes a fisheye lens. In one embodiment, the at least one video camera further includes a low light Complementary Metal-Oxide Semiconductor (CMOS) imager.

In one embodiment, the at least one video camera further includes an adjustable mount adapted to allow the at least one video camera to be pointed in a second direction that is different from the direction.

In one embodiment, the system further includes a jacket adapted to be mounted to the handgrip, wherein the at least one video camera is attached to the jacket.

In one embodiment, the system further includes a data communication device configured for transmitting video data of the at least one video camera to a remote receiver.

In one embodiment, the system further includes a grip panel and a camera support unit, wherein the grip panel is configured to be disposed on one of two sides of the handgrip and the camera support unit is disposed within the grip panel.

In one embodiment, the camera support unit further comprises a rechargeable battery functionally connected to the video camera.

In one embodiment, the system further includes a data recorder functionally connected to the at least one video camera and a functionally coupled wireless device pair, wherein a first wireless device of the wireless device pair is configured to be attached to the handgun and a second wireless device of the wireless device pair is configured to be coupled to a holster of the handgun, wherein if the first and second wireless devices of the wireless device pair are determined to be sufficiently separated by a separation, the video camera and the data recorder are turned on, wherein if the first and second wireless devices are determined to be not sufficiently separated, the video camera and the data recorder are turned off.

An object of the present invention is to provide a video camera system that is adaptable to an existing handgun.

Another object of the present invention is to provide a video camera system-equipped handgun that is adaptable to an existing holster.

Another object of the present invention is to provide a video camera system that is adaptable to a handgun without significantly altering the recoil behavior of the handgun.

Another object of the present invention is to provide a video camera system-equipped handgun where the video camera and its data recorder are turned on at opportune times automatically, avoiding the need to process unnecessary footage, the waste associated with memory storage and power usage of the video camera and data recorder.

Another object of the present invention is to provide a means for recording visual and audio inputs of a scene a handgun is pointed at.

Whereas there may be many embodiments of the present invention, each embodiment may meet one or more of the foregoing recited objects in any combination. It is not intended that each embodiment will necessarily meet each objective. Thus, having broadly outlined the more important features of the present invention in order that the detailed description thereof may be better understood, and that the present contribution to the art may be better appreciated, there are, of course, additional features of the present invention that will be described herein and will form a part of the subject matter of this specification.

### BRIEF DESCRIPTION OF THE DRAWINGS

In order that the manner in which the above-recited and other advantages and objects of the invention are obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is a side partially transparent view of a handgun, depicting one embodiment of a video camera system adapted to the handgun.

FIG. 2 is a top rear perspective partially transparent view of the handgun of FIG. 1.

FIG. 3 is a side partially transparent view of the handgun of FIG. 1, depicting the manner in which a user's hand is gripping the handgrip and does not obscure the field of view of a video camera mounted to the handgrip.

FIG. 4 is a side partially transparent view of a handgun where one embodiment of a video camera system is adapted to the handgun and the handgun is seated in a holster having a wireless device that communicates with a wireless device in the handgrip of the handgun.

FIG. 5 is a rear partially transparent view of the handgun of FIG. 1, depicting the field of view of two video cameras each mounted on one side of the handgun.

FIG. 6 is a rear partially transparent view of the handgun of FIG. 1, depicting the field of view of two video cameras each mounted on one side of the handgun, one video camera of which is supported on a fixed member and another video camera of which is supported on a member having an adjustable joint.

FIG. 7 is a side partially transparent view of one embodiment of a handgun with a video camera system adapted to the trigger guard of the handgun, a harness disposed internally within the handgun which connects a video camera to a camera support unit.

FIG. 8 is a side partially transparent view of one embodiment of a handgun with a video camera system adapted to a jacket that fits around the handgrip of the handgun and the jacket contains a camera support unit and a switch means configured to detect a grip on the jacket.

FIG. 9 is a top rear perspective partially transparent view of the handgun of FIG. 8.

FIG. 10 is a side partially transparent view of a handgun where one embodiment of a video camera system is adapted to the handgun and the video camera system includes two video cameras mounted on one side of the handgun with a first of them configured to be pointed forwardly in a first direction and a second configured to be pointed in the direction opposite that of the first direction.

FIG. 11 is a side partially transparent view of one embodiment of a handgun with a video camera system adapted to the handgrip of the handgun where a video camera of the video camera system is configured to protrude from the handgrip guard of the handgrip.

FIG. 12 is a side partially transparent view of a handgun, depicting one embodiment of a video camera system adapted to the handgrip of the handgun.

FIG. 13 is a top rear perspective partially transparent view of the handgun of FIG. 12.

FIG. 14 is a rear view of a handgun, depicting one embodiment of a video camera system adapted to the handgrip of the handgun.

FIG. 15 is block diagram depicting exemplary components contained in a camera support unit.

FIG. 16 is a sequence diagram of one embodiment of an automatic operation of a video camera of a video camera system configured for use with a handgun.

FIG. 17 is a sequence diagram of one embodiment of an automatic operation of a video camera of a video camera system configured for use with a handgun.

FIG. 18 is a flow diagram depicting an exemplary secondary benefit of the use of a video camera-equipped handgun.

FIG. 19 is a side partially transparent view of a handgun, e.g., revolver, depicting one embodiment of a video camera system adapted to the handgun.

### PARTS LIST

2—handgun
4—handgrip
6—grip panel
8—handgrip guard
10—barrel
12—video camera
14—harness
16—camera support unit
18—holster
20—switch means
22—wireless device
24—remote communication device
26—localization device
28—controller
30—power supply or battery
32—data access port
34—data storage device
36—step of sending data to law enforcement
38—step of processing image for facial recognition
40—fisheye lens
42—jacket
44—video camera field of view
46—audio input device
48—video camera field of view with fisheye lens
50—trigger guard
52—member
54—adjustable joint
56—lateral surface of grip panel

### PARTICULAR ADVANTAGES OF THE INVENTION

In one embodiment, the present video and audio system is adaptable to an existing handgun while not significantly affecting the recoil or firing characteristics of the handgun. In this embodiment, there is provided a jacket configured to be disposed over and snuggly fit to the handgrip of a handgun. At least one video camera is disposed on a portion of the jacket. As the jacket is attached to the handgrip, the additional weight does not create a cantilever effect to recoil when compared to barrel-mounted video camera systems.

In one embodiment, the present video and audio system is configured to be automatically turned on or off, thereby removing the need for manually controlling the system.

In one embodiment, the present video and audio system is configured to be automatically turned on or off based on perceived usage of the handgun, thereby removing the need for manually controlling the system and removing the possibility of inadvertently turning off of the system.

In one embodiment, the present video and audio system is a system where the device which requires an exposure of a scene to be captured, i.e., a video camera is segregated from its support which contains, e.g., battery, data recorder, etc., such that the support unit, which constitute a large portion of the total weight of the system can be disposed in or on the handgrip.

### DETAILED DESCRIPTION OF A PREFERRED EMBODIMENT

The term “about” is used herein to mean approximately, roughly, around, or in the region of. When the term “about” is used in conjunction with a numerical range, it modifies that range by extending the boundaries above and below the numerical values set forth. In general, the term “about” is used herein to modify a numerical value above and below the stated value by a variance of 20 percent up or down (higher or lower).

As used herein, in one instance, the terms “video camera” is used to represent an image capture device (including, e.g., lenses and image sensors, etc.) capable of receiving still images as well as moving images when such image capture device is functionally coupled to supporting devices (including, e.g., controller, flash memory, memory write device, playback device and wired or wireless communication device, etc.) to function as a composite unit to record, broadcast, or transfer captured images to a second device. In another instance, the terms “video camera” is used to represent an image capture device including such other supporting devices.

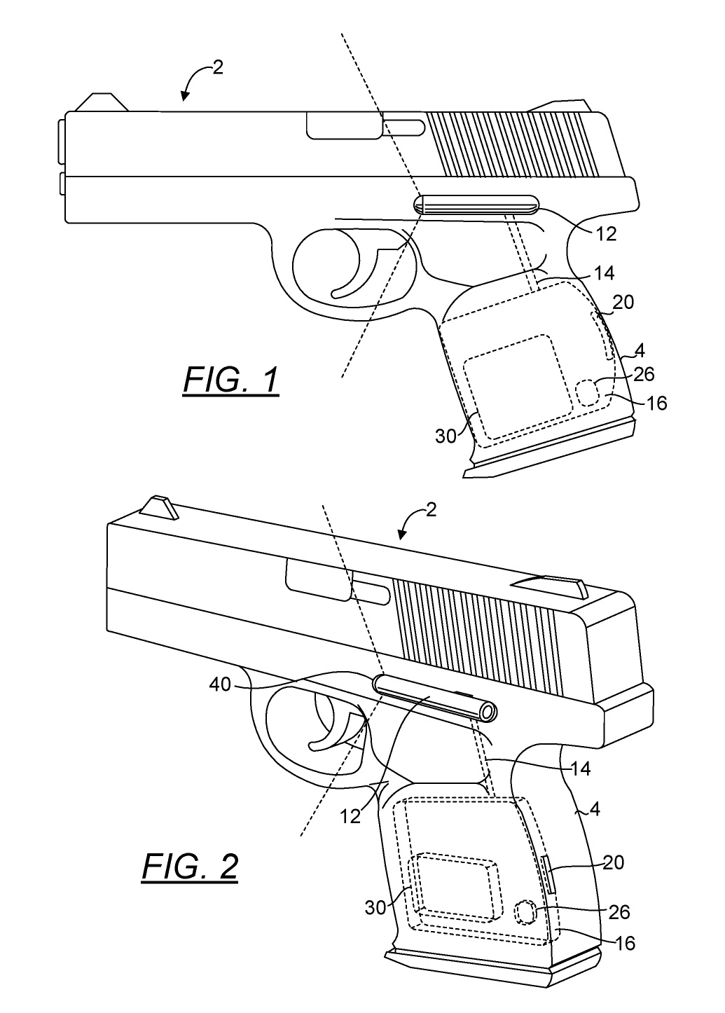

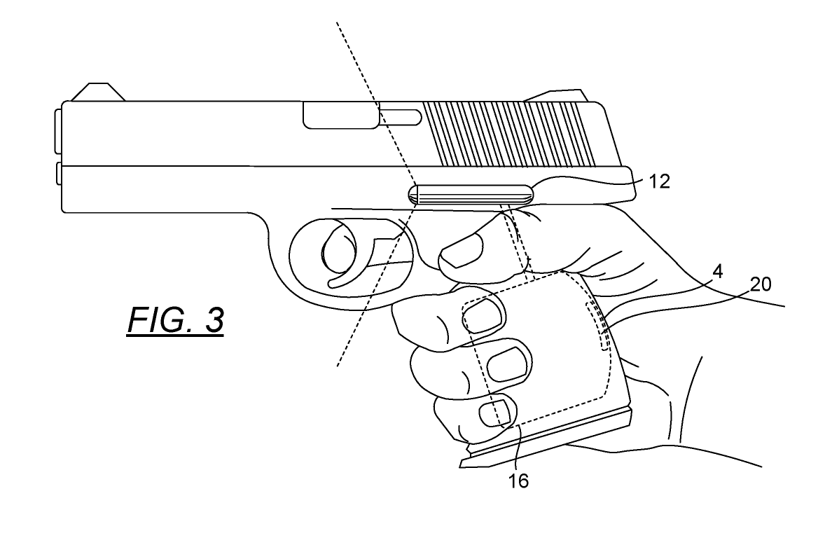

FIG. 1 is a side partially transparent view of a handgun, depicting one embodiment of a video camera system adapted to the handgun 2. FIG. 2 is a top rear perspective partially transparent view of the handgun of FIG. 1. The video camera system includes a video camera 12 that is functionally connected to a camera support unit 16 via harness 14. The video camera 12 is pointed in a direction similar to the direction of a projectile of the handgun. In one embodiment, the camera support unit 16 includes a battery 30 adapted to power the video camera 12. By separating the video camera 12 from the camera support unit 16, the video camera 12 can be made as small as possible in size such that its footprint becomes nonintrusive to a user of the handgun 2. In one embodiment, the camera support unit 16 further includes a switch means 20 attached to a portion of the handgrip 4. In one embodiment, the switch means is a pressure switch or a switch whose state is altered when a pressure is applied to it. The switch means 20 is shown to be disposed within a rear portion of the handgrip 4 as a user can be reliably expected to apply pressure to this portion of the handgrip 4 when the handgrip 4 is grasped although it is conceivable to mount the switch means 20 on another portion of the handgrip 4. In one embodiment, the switch means is a mechanical pressure switch. In another embodiment, the switch means is a heat sensitive switch where the presence of a grasp with a human hand will cause the state of the switch to be altered and detected. In the embodiment shown, the camera support unit 16 is disposed within the handgrip 4, making the majority of the weight of the video camera system be disposed within the grasp of the user, thereby leaving substantially no additional cantilevered weight outside of the grasp of the user. The video camera 12 and switch means 20 are connected to the rest of the camera support unit 16 via harnesses 14. In some handguns, a cavity of a handgrip is occupied by a magazine in which projectiles/bullets are supplied and advanced to be fired from the handgun 2. FIG. 3 is a side partially transparent view of the handgun of FIG. 1, depicting the manner in which a user's hand is gripping the handgrip and does not obscure the field of view of a video camera 12 mounted to the handgrip 4.

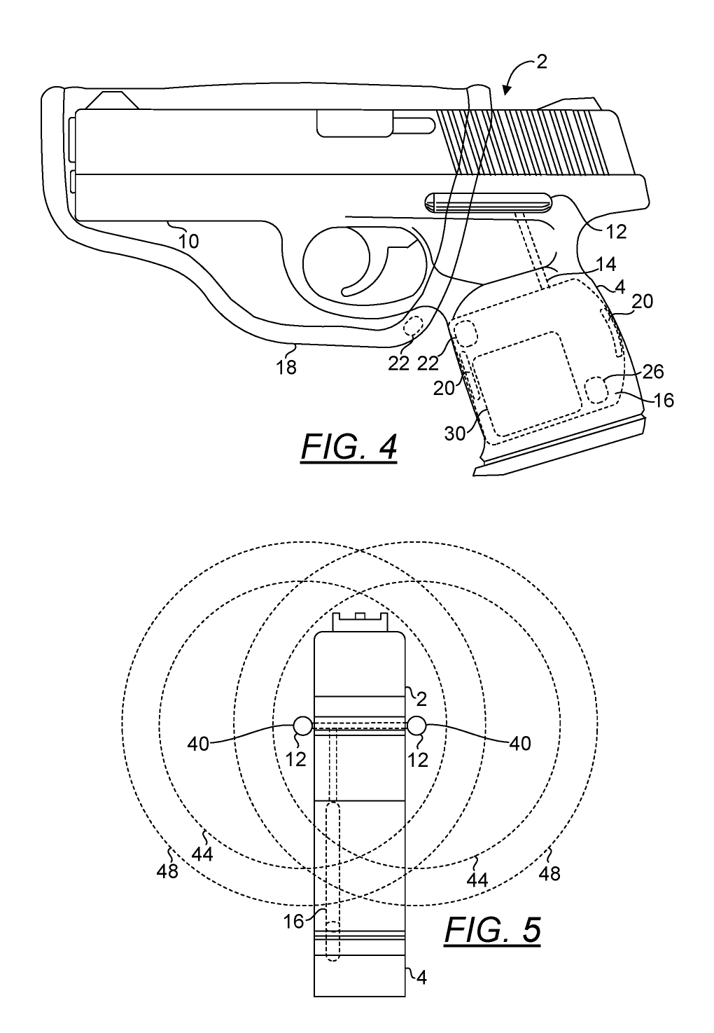

In one embodiment, a mechanism is provided to ensure that the video camera system or at least the visual component, e.g., the video camera, is turned on for operation at only opportune times, i.e., the video camera should not be made to capture images while seated in the holster or when there are no usable images to be had. FIG. 4 is a side partially transparent view of a handgun where one embodiment of a video camera system is adapted to the handgun 2 and the handgun 2 is seated in a holster 18 having a first wireless device 22 that communicates with a second wireless device 22 in the handgrip 4 of the handgun. In one embodiment, the wireless device is a device selected from the group consisting of a radio frequency device, a Bluetooth device, a Wi-Fi device, a Hall Effect device, an induction device, and any combinations thereof. It shall be noted that, although equipped with a video camera system capable of capturing scenes in the direction of projectile trajectories of the handgun 2, the holster made for a handgun without a video camera system can still be utilized. Contrast this with a handgun with a video camera or a video camera system mounted on barrel 10. It shall be appreciated that a barrel-mounted video camera system would have portions that interfere with the holster. In one embodiment, the wireless device pair is a radio frequency device pair, e.g., Near Field Communication (NFC) device pair and the wireless devices 22 are separated by a distance of less than about 4 cm while the handgun 2 is seated in the holster 18. The wireless device pair includes two parts that are functionally coupled together. Any wireless device capable of such a coupling may be used. In one instance, the wireless device 22 attached to the holster 18 is an NFC tag and the wireless device 22 attached to the handgun 2 is an NFC transceiver capable of transmitting radio frequency signals, receiving and distinguishing returned signals due to the NFC tag or its general environment. In use, a separation or a lack of separation of the wireless devices 22 can is used to turn on the video camera system as disclosed elsewhere herein. In one embodiment, the separation is a loss of communication between the functionally connected wireless device pair. In another embodiment, the separation is an event where a distance between the functionally coupled wireless device pair exceeding a pre-determined threshold. In one embodiment, a separation is a physical distance of about 4 cm.

FIG. 5 is a rear partially transparent view of the handgun of FIG. 1, depicting the field of view of two video cameras 12 each mounted on one side of the handgun 2. Although not obscured by a user's hand, as a video camera 12 is mounted on a side of the handgun 2, the field of view 44 of the video camera 12 is partially blocked by the handgun 2 itself. Therefore, a second video camera 12 may be used to capture the view on the opposing side of the first video camera 12 to add to the total field of view that can be had. Therefore, although a single video camera mounted on a top portion of handgrip 4 may not capture all of the intended scene, it provides sufficient breadth of the scene that is pointed at. A second video camera provides a supplementary field of view of the field of view of the first camera. In one embodiment, each of the two video cameras further includes a fisheye lens 40 for expanding the field of view of each of the two video cameras. Also depicted on FIG. 5 are fields of view 48 that result from the use of fisheye lenses. In some embodiments, a low light Complementary Metal-Oxide Semiconductor (CMOS) imager is used in conjunction with a present video camera to allow the video camera to yield high quality images under low light conditions. In one embodiment, a suitable low light CMOS imager is one capable of imaging in near infrared wavelengths outside of the human visible range of about 390-700 nm to prevent the handgun from being the target of an assailant to the user of the handgun.

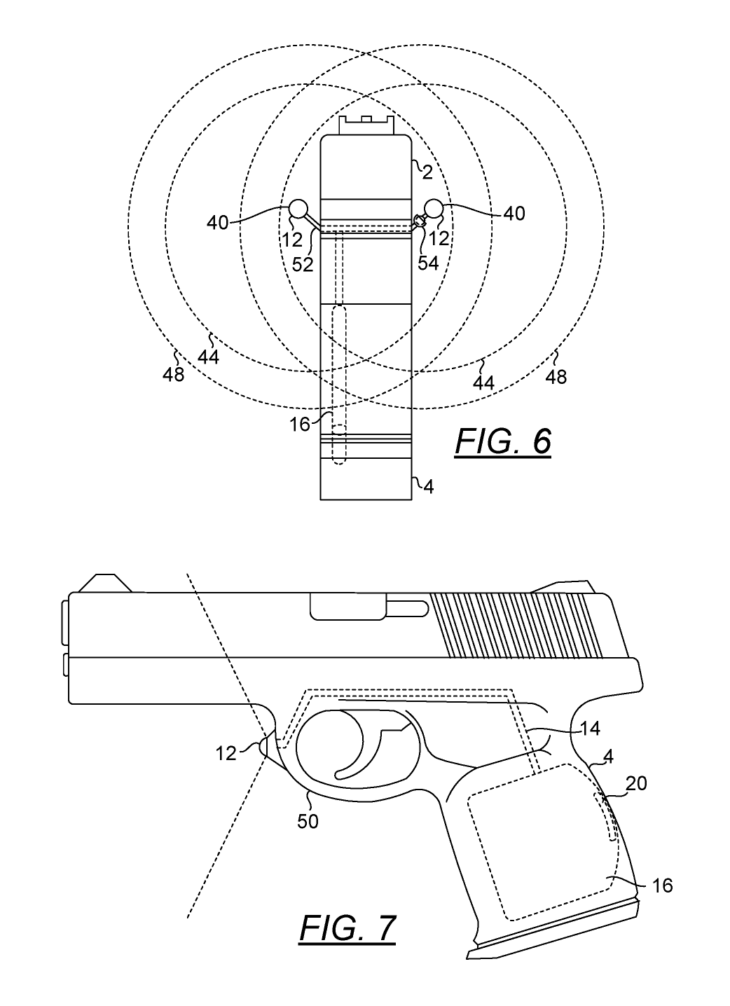

FIG. 6 is a rear partially transparent view of the handgun of FIG. 1, depicting the field of view of two video cameras each mounted on one side of the handgun, one video camera of which is supported on a fixed member 52 and another video camera of which is supported on a member having an adjustable joint 54. The left member 52 is a fixed extension protruding from a top portion of the handgrip 4, increasing the portion of the field of view of the video camera 12 that is unimpeded. The right member 52 is an adjustable extension protruding from a top portion of the handgrip 4, enabling one to increase the portion of the field of view of the video camera 12 that is unimpeded and to point the video camera 12 in a number of directions.

FIG. 7 is a side partially transparent view of one embodiment of a handgun with a video camera system adapted to the trigger guard 50 of the handgun, a harness 14 disposed internally within the handgun which connects a video camera 12 to a camera support unit 16. As shown herein, in one embodiment, there is further provided a video camera configured to be disposed on the trigger guard 50 of a handgun 2 where the video camera 12 having a field of view pointed in a direction substantially similar to the direction of a projectile of the handgun 2. Compared to the embodiments shown in FIGS. 1-5, the field of view of the video camera 12 of FIG. 7 is not as limited. However, the additional mass due to the video camera 12 is moved further away from the handgrip 4 and a longer harness 14 is required to be supplied internally within the handgun to the video camera 12.

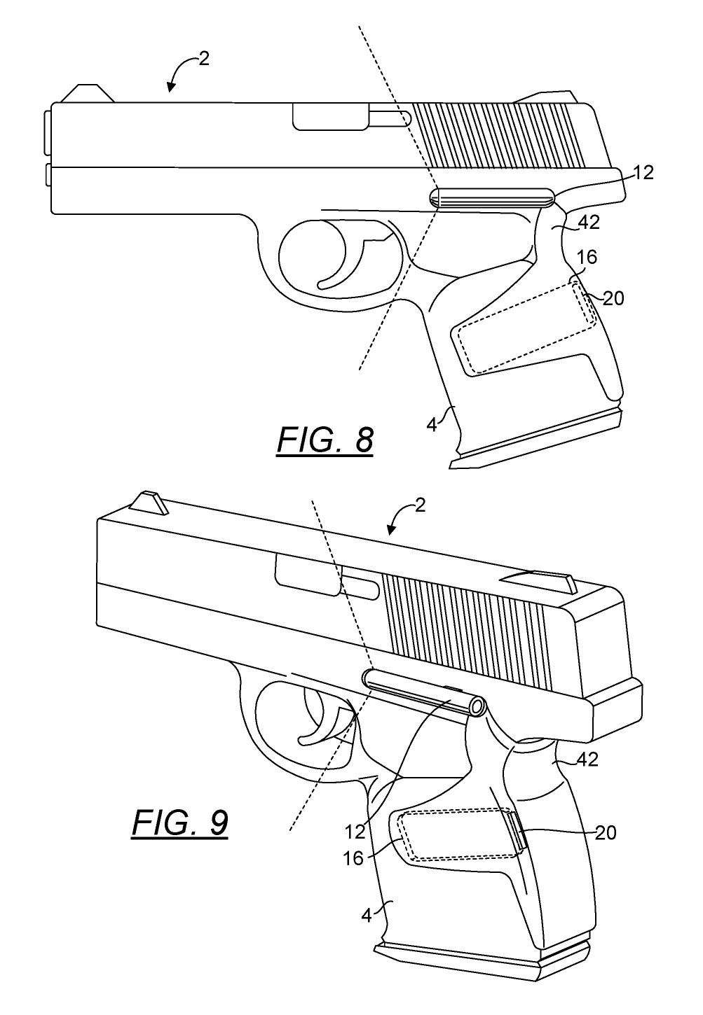

FIG. 8 is a side partially transparent view of one embodiment of a handgun with a video camera system adapted to a jacket 42 that fits around the handgrip 4 of the handgun 2 and the jacket 42 contains a camera support unit 16 and a switch means 20 configured to detect a grip on the jacket 42. FIG. 9 is a top rear perspective partially transparent view of the handgun of FIG. 8. A video camera 12 is attached to the jacket 42 where the video camera 12 is disposed such that when the jacket 42 is secured to the handgrip 4, the video camera 12 is pointed in the direction of a projectile of the handgun 2.

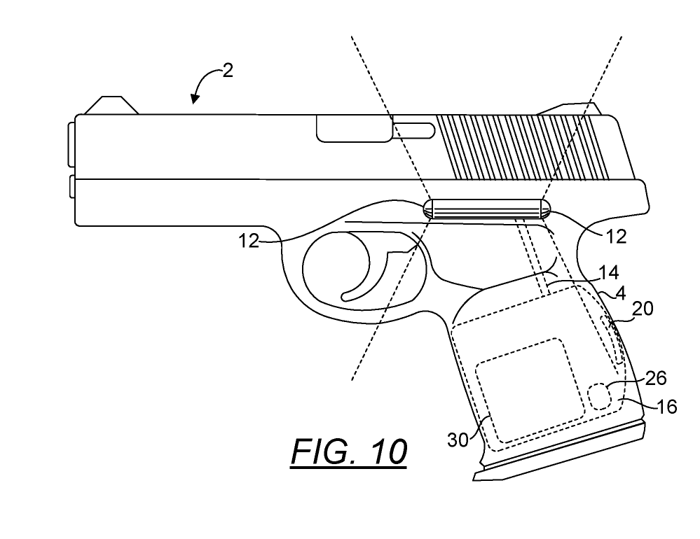

FIG. 10 is a side partially transparent view of a handgun where one embodiment of a video camera system is adapted to the handgun and the video camera system includes two video cameras 12 mounted on one side of the handgun 2 with a first of them configured to be pointed forwardly in a first direction and a second configured to be pointed in the direction opposite that of the first direction. In this embodiment, the amount of visual information is increased tremendously as the user now falls in the field of view of a video camera. In some circumstances, the availability of this increased information collection can prove to be critical, especially if the user is at the receiving end of a gunfire. As the second video camera 12 is mounted on the handgrip and pointed towards a user, its field of view is not as severely obscured as the field of view of the first video camera 12 would be due to the barrel, trigger and trigger guard, etc.

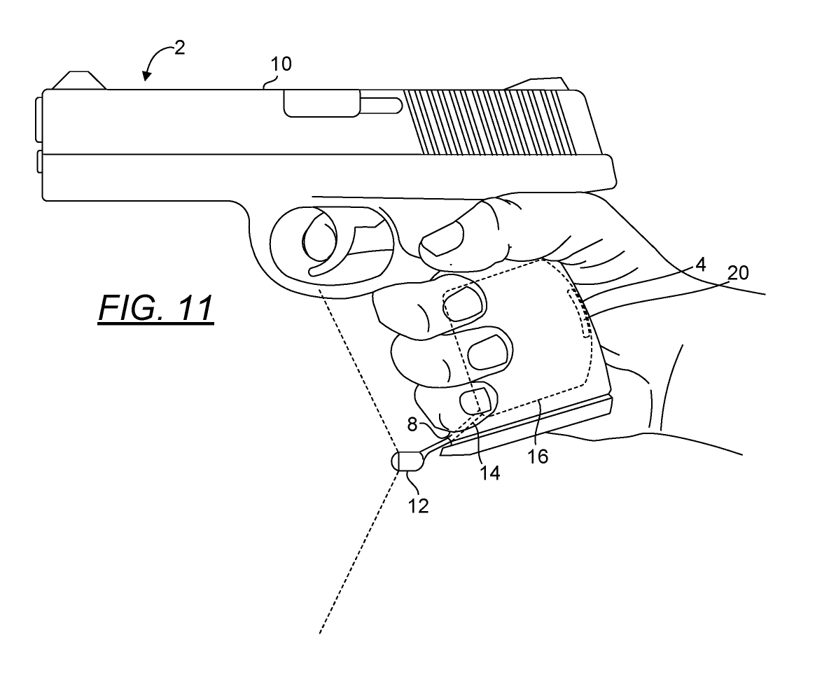

FIG. 11 is a side partially transparent view of one embodiment of a handgun 2 with a video camera system adapted to the handgrip of the handgun where a video camera of the video camera system is configured to protrude from the handgrip guard 8 of the handgrip 4. Again, the field of view of the video camera 12 is pointed in a direction substantially similar to the direction of a projectile of the handgun and the camera is configured to be disposed on the handgrip guard 8.

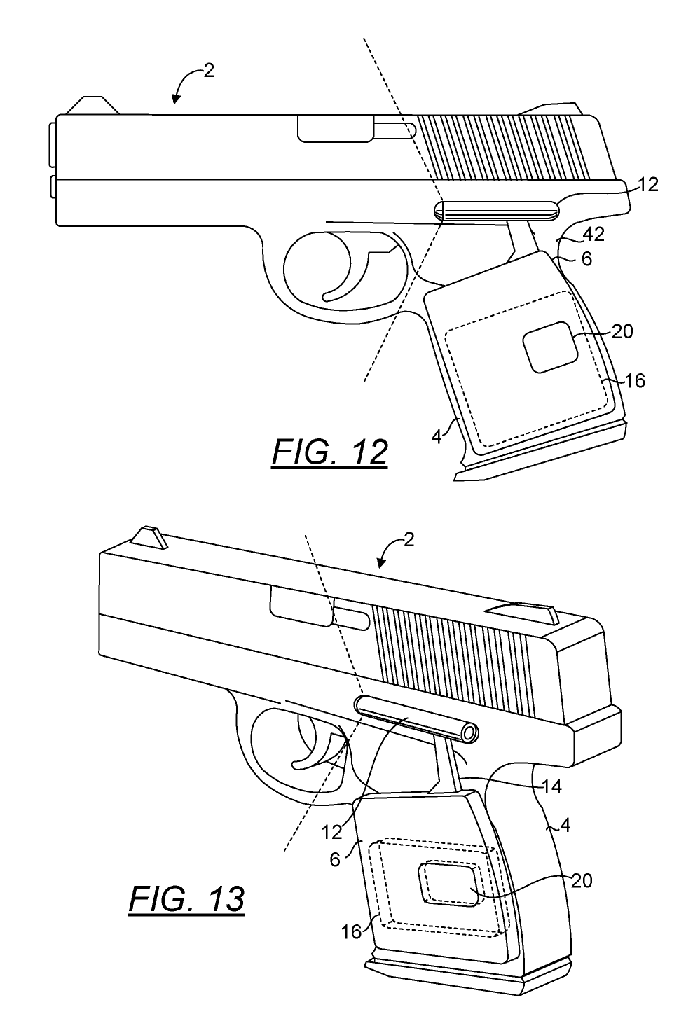

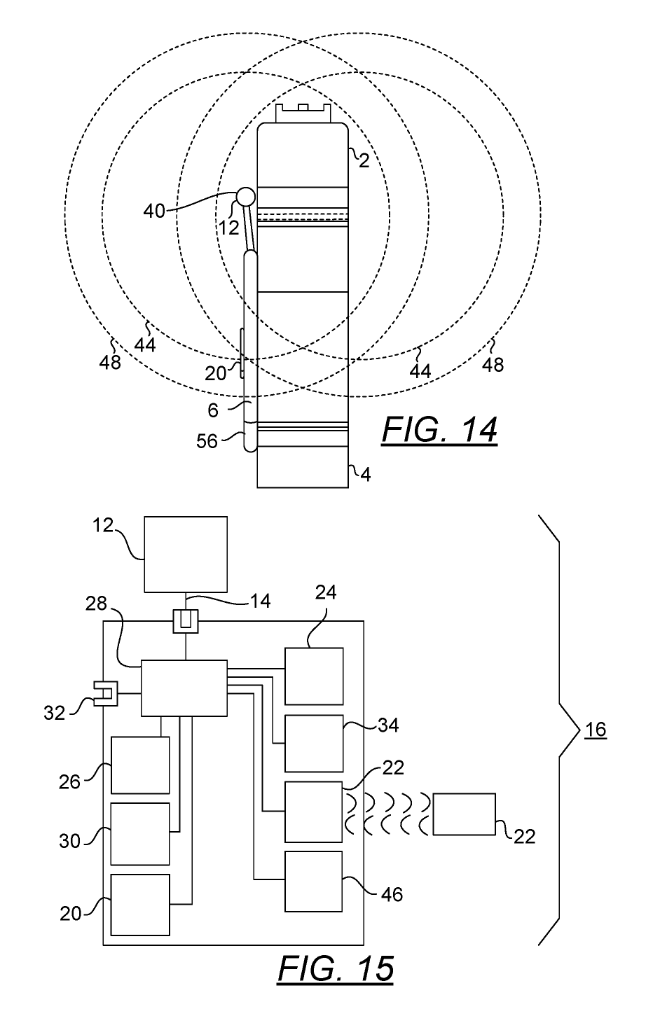

FIG. 12 is a side partially transparent view of a handgun, depicting one embodiment of a video camera system adapted to the handgrip of the handgun. FIG. 13 is a top rear perspective partially transparent view of the handgun of FIG. 12. FIG. 14 is a rear view of a handgun, depicting one embodiment of a video camera system adapted to the handgrip of the handgun. In one embodiment, the system further includes a grip panel 6 having a lateral surface 56 and a switch 20 configured to selectively turn on or off the video camera and the data recorder. The grip panel 6 is configured to be disposed on one of two sides of the handgrip 4 and the switch is removably attached to the lateral surface 56 of the grip panel 6 so as to be accessible on the lateral surface of the grip panel. In one embodiment, the system further includes a grip panel 6 and a camera support unit 16, wherein the grip panel is configured to be disposed on one of two sides of the handgrip 4 and the camera support unit 16 is disposed within the grip panel 6.

FIG. 15 is block diagram depicting exemplary components contained in a camera support unit 16. As shown herein, the camera support unit 16 includes a localization device 26, e.g., Global Positioning System (GPS) device for reporting a location of a handgun as the GPS is configured to be disposed within the handgrip of the handgun, a power supply 30, e.g., a rechargeable battery, a switch means 20, e.g., a pressure switch and a mechanical on-off contact switch, a data storage device 34, i.e., a flash memory device, a remote communication device 24, i.e., a device configured for Wide Fidelity (Wi-Fi), Bluetooth® or cellular communication, a wireless device 22 pair configured for determining whether the pair are separated, an audio input device 46, e.g., microphone, for capturing audio input from its surroundings, all of which are functionally connected to a controller 28. A video camera 12 is also functionally connected to the controller 28 via which the video camera 12 is turned on or off, visual data obtained via the video camera 12 is channeled to be stored to the data storage device 34 and/or transmitted or broadcast directly in real time or near real time manner via remote communication device 24 to be cached in a remote data receiver, e.g., a data storage device, server, data center, etc. In the embodiment shown, there is further provided a data access port 32 configured for receiving a portable data storage device, e.g., a flash memory device (onto which visual and audio data may be downloaded from the onboard data storage device). As such, recorded data, e.g., images or videos may be obtained with a communication cable from the camera support unit 16 via this port 32 or data obtained via the video camera 12 may be remotely and/or wirelessly transmitted in real time/near real time to a data storage device. In one embodiment, the video camera 12 and the data storage device 34 are tightly coupled in function, i.e., as long as the video camera 12 is turned on, the data storage device 34 is also turned on to record and store the information obtained via the video camera 12. In one embodiment, the video camera 12, the audio input device 46 and the data storage device 34 are tightly coupled in function, i.e., as long as the video camera 12 is turned on, the audio input device 46 and the data storage device 34 are also turned on to record and store the information obtained via the video camera 12 and audio input device 46.

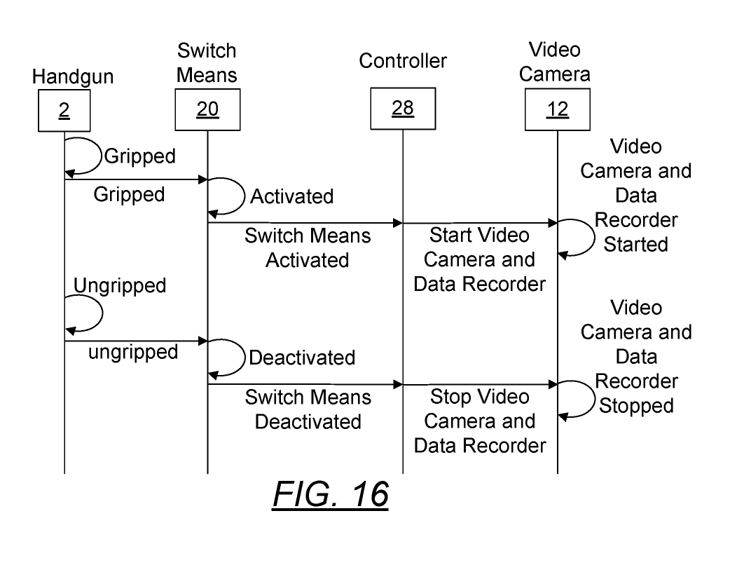

FIG. 16 is a sequence diagram of one embodiment of an automatic operation of a video camera of a video camera system configured for use with a handgun. In the embodiment, the video camera system further includes a switch means 20 configured to detect a grip of the handgrip 4 and a data recorder functionally connected to the at least one video camera, wherein upon the detection of a grip, the video camera and the data recorder are turned on and upon cessation of the detection of a grip, the video camera 12 and the data recorder are turned off. When the handgrip of a handgun 2 is grasped, e.g., in the hand of a user, switch means 20 of the handgun 2 is activated, causing this signal to be communicated to the controller 28 which in turn sends a signal to start the video camera 12 and the data recorder. When the grasp of the handgrip is released, e.g., upon seating the handgun in a holster, the switch means 20 is deactivated and a signal is communicated to the controller 28 to indicate that the video camera and data recorder may now be turned off. A signal is in turn sent to turn off the video camera 12 and data recorder. In one embodiment, the video camera and the data recorder are not turned off upon cessation of the detection of a grip. A delay is started upon cessation of the detection of a grip and upon expiration of the delay, the video camera and the data recorder are turned off.

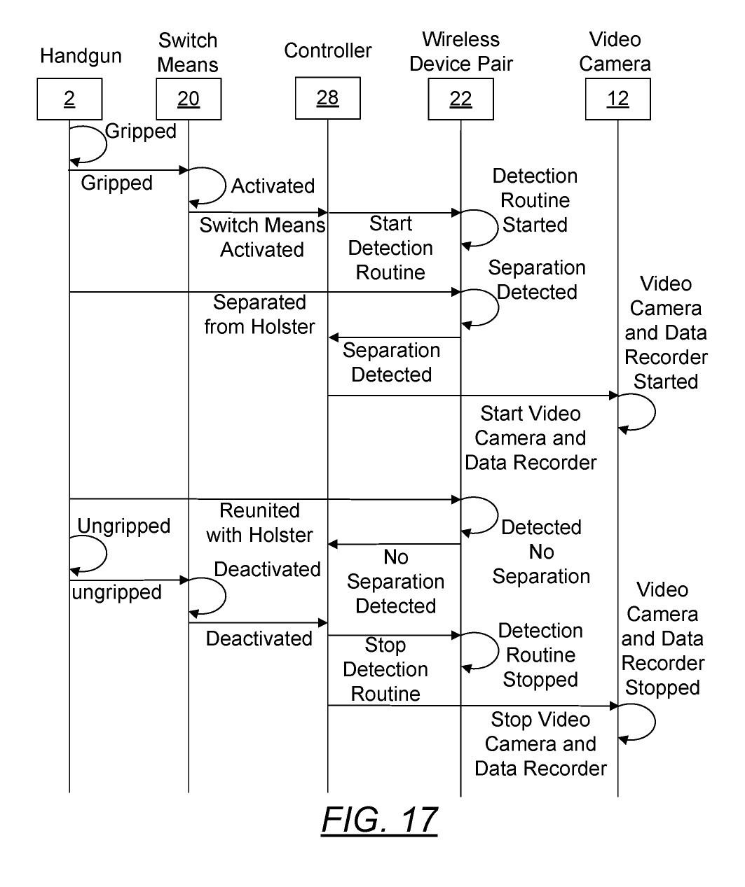

FIG. 17 is a sequence diagram of one embodiment of an automatic operation of a video camera of a video camera system configured for use with a handgun. In one embodiment, the system further includes a switch means 20 configured to detect a grip of the handgrip, a data recorder functionally connected to the at least one video camera and a functionally coupled wireless device pair, wherein a first wireless device of the wireless device pair is configured to be attached to the handgun and a second wireless device of the wireless device pair is configured to be coupled to a holster of the handgun, wherein upon the detection of a grip, proximity detection of the wireless device pair is started, and if the first and second wireless devices of the wireless device pair are determined to be sufficiently separated by a separation, the video camera and the data recorder are turned on, wherein if the detection of a grip does not occur and if the first and second wireless devices are determined to be not sufficiently separated, then the video camera and the data recorder are turned off. In this embodiment, the mechanism to start or stop a video camera 12 and data recorder is not the switch means 20 itself. The switch means 20 is instead used in the same manner as disclosed in FIG. 16 to turn on a detection routine to a wireless device pair 22. It is a perceived separation of the handgun from its holster which starts the video camera 12 and the data recorder and a perceived reunion of the handgun from its holster which stops the video camera 12 and the data recorder. In one embodiment, although less desirably, the detection or the lack of detection of a grip is not used to start or stop proximity detection of the wireless pair. Instead, proximity detection of the wireless pair is configured to occur at all times. In one embodiment, proximity detection of the wireless pair is configured to occur when a switch is manually turned on. In one embodiment, proximity detection of the wireless pair is configured to cease when the switch is manually turned off.

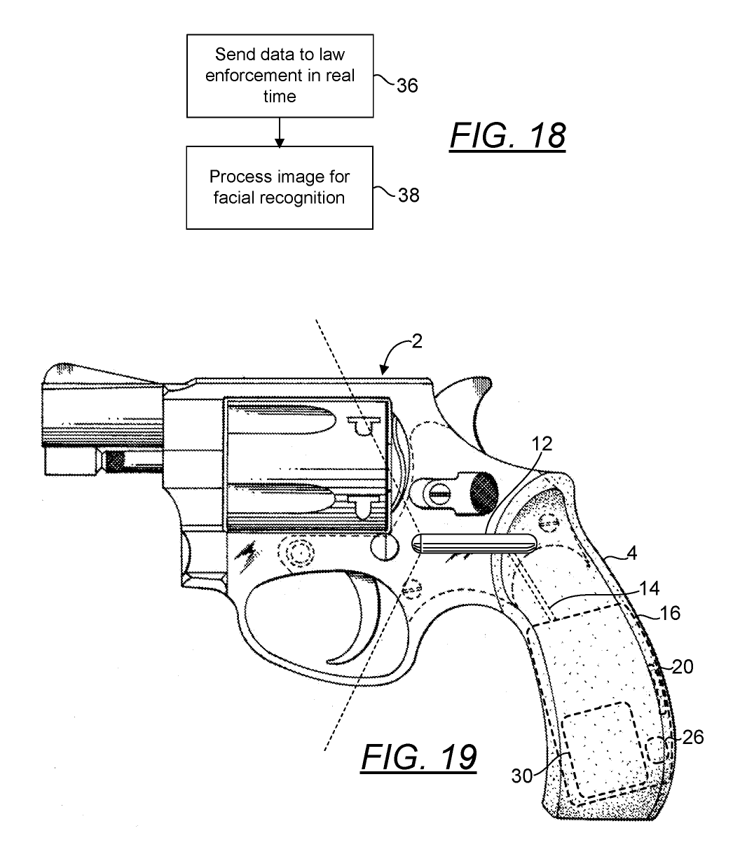

FIG. 18 is a flow diagram depicting an exemplary secondary benefit of the use of a video camera-equipped handgun. In step 36, data obtained via a video camera and an audio input device is streamed or transmitted in real time via a remote communication device, e.g., cellular or Wi-Fi network to a remote computer used by law enforcement. In step 38, the streamed data can be processed, e.g., for facial recognition of the subject appearing in the visual data obtained via the video camera. Further, if an audio database of individuals is available, the identity of the subject may further be verified against the database. Rapid identification of subject pointed at using a handgun can be a matter of life and death both for the subject or the law enforcement officer using the handgun, e.g., if the subject is determined to be lacking a history of violence, the deadly force capable of being exerted by the handgun may be avoided. On the other hand, if the subject is determined to be one who have murdered before, then the officer may be informed, in real time as a result of the real time identification of the subject, of the violence tendency in the subject and deadly fire by the officer may be necessary to defuse a highly volatile situation.

FIG. 19 is a side partially transparent view of a handgun 2, e.g., revolver, depicting one embodiment of a video camera system adapted to the handgun 2. Again, a video camera 12 is disposed at a top portion of the handgrip 4 of the handgun 2 and its camera support unit 16 is disposed within the handgrip 4.

The detailed description refers to the accompanying drawings that show, by way of illustration, specific aspects and embodiments in which the present disclosed embodiments may be practiced. These embodiments are described in sufficient detail to enable those skilled in the art to practice aspects of the present invention. Other embodiments may be utilized, and changes may be made without departing from the scope of the disclosed embodiments. The various embodiments can be combined with one or more other embodiments to form new embodiments. The detailed description is, therefore, not to be taken in a limiting sense, and the scope of the present invention is defined only by the appended claims, with the full scope of equivalents to which they may be entitled. It will be appreciated by those of ordinary skill in the art that any arrangement that is calculated to achieve the same purpose may be substituted for the specific embodiments shown. This application is intended to cover any adaptations or variations of embodiments of the present invention. It is to be understood that the above description is intended to be illustrative, and not restrictive, and that the phraseology or terminology employed herein is for the purpose of description and not of limitation. Combinations of the above embodiments and other embodiments will be apparent to those of skill in the art upon studying the above description. The scope of the present disclosed embodiments includes any other applications in which embodiments of the above structures and fabrication methods are used. The scope of the embodiments should be determined with reference to the appended claims, along with the full scope of equivalents to which such claims are entitled.

I claim:

1. A video camera system for a handgun having two sides and a handgrip, the video camera system comprising:
at least one video camera having a field of view pointed in a direction substantially similar to the direction of a projectile of the handgun and said at least one video camera is configured to be disposed on at least one of the two sides of the handgun at a top portion of the handgrip.

2. The video camera system of claim 1, further comprising at least one second video camera having a field of view pointed in a direction opposite to said field of view of said at least one video camera.

3. The video camera system of claim 1, further comprising a camera support unit functionally coupled to said at least one video camera, said camera support unit is configured to be disposed within the handgrip.

4. The video camera system of claim 3, wherein said camera support unit comprises a battery adapted to power said at least one video camera.

5. The video camera system of claim 1, the system further comprises a Global Positioning System (GPS) configured to indicate a location of the handgun.

6. The video camera system of claim 1, further comprising a switch means configured to detect a grip of the handgrip and a data recorder functionally connected to said at least one video camera, wherein upon said detection of a grip, said video camera and said data recorder are turned on and upon cessation of said detection of a grip, said video camera and said data recorder are turned off.

7. The video camera system of claim 6, wherein said switch means is a switch selected from the group consisting of a mechanical pressure switch and a heat sensitive switch.

8. The video camera system of claim 6, wherein said data recorder comprises a data access port.

9. The video camera system of claim 6, wherein said data recorder comprises a remote communication device configured to transmit data of said data recorder to another device.

10. The video camera system of claim 6, further comprising a switch means configured to selectively turn on or off said at least one video camera and said data recorder.

11. The video camera system of claim 6, further comprising a grip panel having a lateral surface and a switch configured to selectively turn on or off said video camera and said data recorder, said grip panel is configured to be disposed on one of two sides of the handgrip and said switch is removeably attached to said lateral surface of said grip panel so as to be accessible on said lateral surface of said grip panel.

12. The video camera system of claim 1, further comprising a switch means configured to detect a grip of the handgrip, a data recorder functionally connected to said at least one video camera and a functionally coupled wireless device pair, wherein a first wireless device of said wireless device pair is configured to be attached to the handgun and a second wireless device of said wireless device pair is configured to be coupled to a holster of the handgun, wherein upon said detection of a grip, proximity detection of said wireless device pair is started, and if said first and second wireless devices of said wireless device pair are determined to be sufficiently separated by a separation, said video camera and said data recorder are turned on, wherein if said detection of a grip does not occur and if said first and second wireless devices are determined to be not sufficiently separated, said video camera and said data recorder are turned off.

13. The video camera system of claim 12, wherein said separation is an event selected from the group consisting of a loss of communication between said functionally connected wireless device pair and a distance between said functionally coupled wireless device pair exceeding a pre-determined threshold.

14. The video camera system of claim 12, wherein the wireless device is a device selected from the group consisting of a radio frequency device, a Bluetooth device, a Wide Fidelity (Wi-Fi) device, a Hall Effect device, an induction device, and any combinations thereof.

15. The video camera system of claim 1, further comprising an audio input device configured to receive audio input from the surroundings of the handgun.

16. The video camera system of claim 1, wherein said at least one video camera further comprises an equipment selected from the group consisting of a fisheye lens and a low light Complementary Metal-Oxide Semiconductor (CMOS) imager.

17. The video camera system of claim 1, wherein said at least one video camera further comprises an adjustable mount adapted to allow said at least one video camera to be pointed in a second direction that is different from said direction.

18. The video camera system of claim 1, further comprising a jacket adapted to be mounted to the handgrip, wherein said at least one video camera is attached to said jacket.

19. The video camera system of claim 1, further comprising a data communication device configured for transmitting video data of said at least one video camera to a remote receiver.

20. The video camera system of claim 1, further comprising a grip panel and a camera support unit, wherein said grip panel is configured to be disposed on one of two sides of the handgrip and said camera support unit is disposed within said grip panel.

21. The video camera system of claim 1, wherein said camera support unit further comprises a rechargeable battery functionally connected to said at least one video camera.

22. The video camera system of claim 1, further comprising a data recorder functionally connected to said at least one video camera and a functionally coupled wireless device pair, wherein a first wireless device of said wireless device pair is configured to be attached to the handgun and a second wireless device of said wireless device pair is configured to be coupled to a holster of the handgun, wherein if said first and second wireless devices of said wireless device pair are determined to be sufficiently separated by a separation, said video camera and said data recorder are turned on, wherein if said first and second wireless devices are determined to be not sufficiently separated, said video camera and said data recorder are turned off.
